(19) United States
(12) Patent Application Publication
(10) Pub. No.: US 2002/0183004 A1
(43) Pub. Date: Dec. 5, 2002

(54) Beacon infrastructure

(75) Inventors: Paul M. Fulton, Salfords (GB); Paul J. Rankin, Horley (GB); Johanes A. Jansen, London (GB); David P. Walker, Redhill (GB); Robert J. Davies, Horley (GB); Guillaume Blanc, Nice (FR); Jean-Christophe Dupuy, Le Cannet (FR)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/099,681

(22) Filed: Mar. 15, 2002

(30) Foreign Application Priority Data
Mar. 20, 2001 (GB) 0106842.8
Mar. 20, 2001 (GB) 0106839.4
Oct. 17, 2001 (GB) 0124883.0

(51) Int. Cl. H04B 5/00; H04Q 7/20; H04M 11/00

(52) U.S. Cl. 455/41; 455/421

(57) ABSTRACT

A communications system uses a transmitter beacon (70) for transmitting alert signals to mobile receivers. Each alert signal prompts an alert message of the transmitter beacon. Interpretation data is loaded into the mobile receiver and is used when an associated alert signal is received, thereby to generate the associated alert message at the mobile wireless device.

The present invention relates to mobile communications devices, such as telephones and suitably equipped personal digital assistants (PDA's), and to infrastructure systems and protocols for use with the same.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. Such “Context-Aware” (CA) mobile telephones are used with low power, short range base stations in places like shopping malls to provide location-specific information. This information might include local maps, information on nearby shops and restaurants and so on. The user's CA terminal may be equipped to filter the information received according to pre-stored user preferences and the user is only alerted if an item of data of particular interest has been received.

Commonly-assigned International patent application EP 01/06948 (priority date Aug. 15, 2000), describes a CA terminal and puts forward the concept of broadcasting data before a connection is made according to Bluetooth protocols. It exploits the Bluetooth Inquiry phase by extending the very short ID packet sent out during this mode and using the extra space thus gained to carry a small amount of information. This information can be Bluetooth system related data or one-way application data. This scheme has the potentially useful feature of being backwards-compatible with legacy Bluetooth devices that are not able to understand this extra field.

This only enables a small amount of information to be transferred, and a problem therefore arises in transferring significant quantities of data using this approach.

According to a first aspect of the invention, there is provided a communications system comprising:

a transmitter beacon for transmitting a plurality of alert signals to wireless receivers within range of the beacon, each alert signal being provided for prompting an alert message of the transmitter beacon; and

a wireless receiver which stores interpretation data, selected interpretation data being used when an associated alert signal is received, thereby to generate the associated alert message at the mobile wireless device.

The CA concept is about using a mobile handset to receive special pushed messages from publicly located RF beacons. The invention enables short alert messages to be used which are then interpreted based on data stored in the wireless device. The interpretation data may comprise sound or image files.

Preferably, the system comprises:

a first group of beacon devices for wirelessly broadcasting data, the wireless receiver being for receiving data from the beacon devices of the first group,

wherein at least one of the beacon devices of the first group is arranged to provide the interpretation data to the wireless receiver to enable the wireless receiver to interpret signals from the beacon devices of the first group.

This provides an arrangement of beacons which operate together in a coordinated system. A number of beacons are collected together to form a “Master Aura” (a group of beacons), within which services of a particular type are available from the operator owning the beacons. Some of the beacons are given the task of acting as “Initialisers”, and provide the interpretation data. These special beacons can be the first point of contact for handsets entering the Master Aura.

As well as providing data to the mobile receiver, they may be able to receive identity and profile information from the mobile receiver, and pass this information on to initialise the other beacons in the Aura. Additionally, they may prime the handset with special sound files or other content relating to the user alerts that the handset may generate. By use of this procedure, whenever a handset moves near a beacon and receives a pushed message from it, it will already hold the appropriate resources to generate a specialised alert. This saves time and removes the need for duplex communication between a handset and a beacon.

Preferably, the communications system further comprises a second group of beacon devices for wirelessly broadcasting data, wherein the at least one wireless receiver is for receiving data from the beacon devices of the first and second groups and wherein at least one of the beacon devices of the second group is arranged to provide interpretation data to the wireless receiver to enable the wireless receiver to interpret signals from the beacon devices of the second group.

Different interpretation data can thus be given to receivers in different Auras (i.e. with the range of beacons of different groups) so that signals from the beacons can be interpreted differently dependent on the Aura within which the receiver is located.

Each beacon device may be for broadcasting data using the Bluetooth protocol.

The interpretation data may for example comprise sound files or content which can be displayed during a connection procedure. The latter allows pre-load from the initialiser of interaction forms or scripts. If a user decides to follow up an alert and requests a WAP connection, the lengthy connection time is disguised by presenting the user with the interaction forms or scripts, thereby keeping the user occupied during the possibly lengthy set up procedure.

At least one of the beacon devices (the initialiser beacon) is preferably arranged to receive data relating to the identity of the wireless receiver during the provision of the interpretation data. This information can then be passed to the other beacons in the group so that they can be aware of the identity and/or profiles of the users within the area of the group of beacons. For this purpose, the initialiser beacon comprises means for passing the data relating to the identity of the wireless receiver to the other beacons of the group.

The other beacon devices of a group of beacons can then filter potential messages to be sent in dependence on the data relating to the identity of the wireless receivers.

The invention also provides a method of providing information to a mobile receiver from a beacon device, the method comprising:

providing interpretation data to the wireless receiver to enable the wireless receiver to interpret signals from the beacon device; and

providing a signal from the beacon device when the wireless receiver is within range of the beacon device, the wireless receiver interpreting the signal using the interpretation data.

This provides the operation for preloading interpretation data described above. The interpretation data may be provided to the wireless receiver from a second beacon device when the wireless receiver is within range of the second beacon device, or it may be provided to the wireless receiver during a preload operation remote from the beacon device.

The wireless receiver may be movable between a plurality of groups of beacon devices, and wherein the method comprises:

providing interpretation data from a first beacon device within each group to the wireless receiver when the wireless receiver is within range of the first beacon device; and

providing a signal from a second beacon device within the group when the wireless receiver is within range of the second beacon device, the wireless receiver interpreting the signal using the interpretation data.

Further features and advantages of the present invention will become apparent from reading of the following description of preferred embodiments of the present invention, given by way of example only, and with reference to the accompanying drawings, in which:

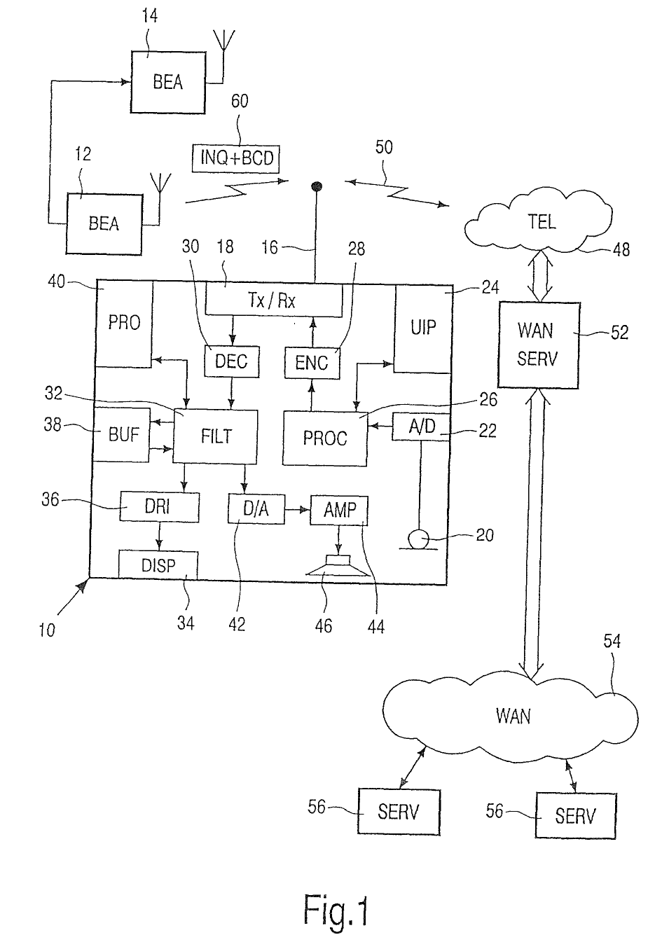

FIG. 1 is a block schematic diagram of a beacon and a portable device for use in the network embodying the invention;

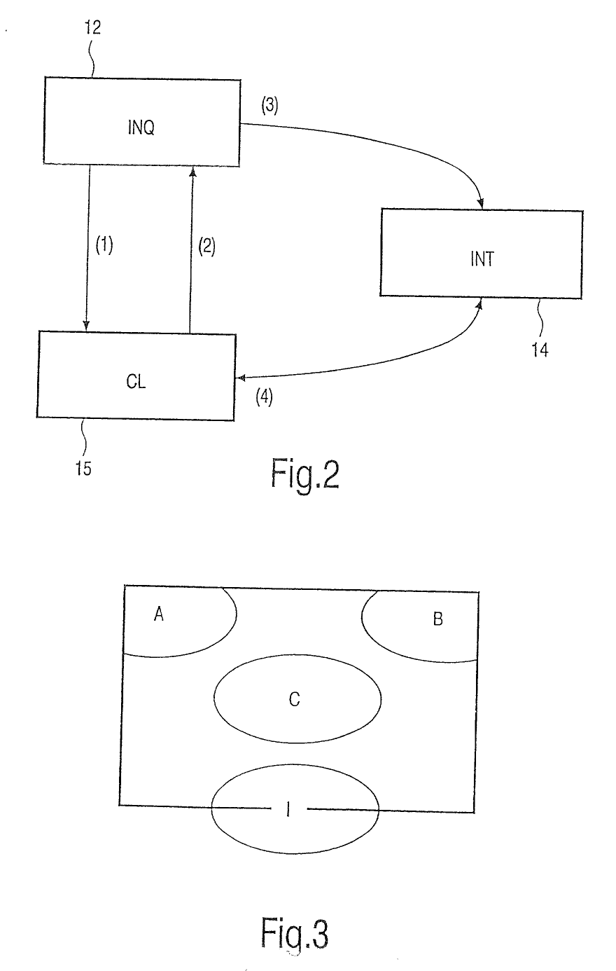

FIG. 2 is a block schematic diagram representing message establishment and hand-over in a system of multiple beacons;

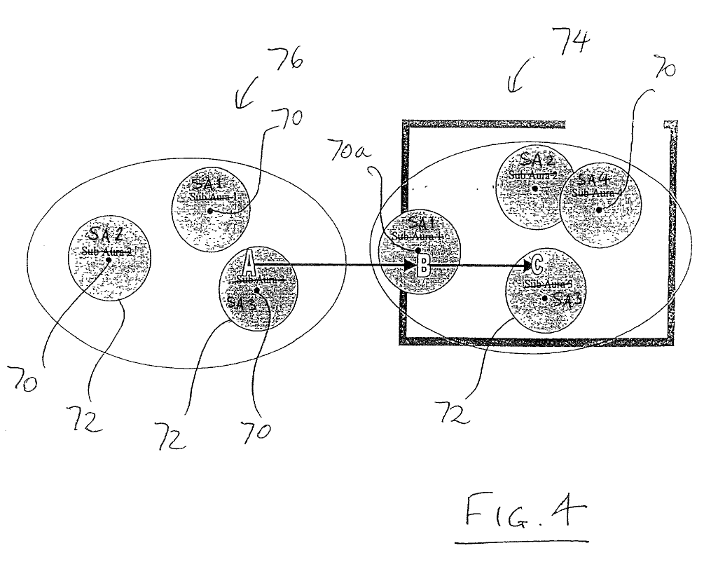

FIG. 3 is a schematic of a multiple beacon network; and

FIG. 4 is a schematic representation of an arrangement of beacons in accordance with the invention.

Many services and applications are proposed for Context Aware (CA) support services that are pushed to the user. In the CA scenarios the user is wandering through a shopping mall and may receive pushed information including advertisements from shops, public transport information, personal information (friends alert), navigational information. Depending on the source of the information and the particular nature of the content, each push message can be given a class identification code. Based on that “class id” and other administrative fields in the message, the user's handset is capable of performing filtering and sorting procedures on the data. This is done so that only messages which are considered relevant and desirable to the user in their current context are chosen for alerting to the user. The alerts themselves may take the form of sound clips, images, simple text or more complex modes such as handset vibration.

The invention relates to the nature of the messages sent from a beacon device to a wireless receiver, and also relates to the architecture of a number of beacons in different areas, and the manner by which different information is provided to mobile receivers when in different locations. Before describing the invention in detail, the architecture of an individual receiver which can be used in the network of the invention is described.

FIG. 1 is a block schematic diagram of a CA mobile telephone 10 in use with a pair of interconnected low power, short range base stations or beacons 12, 14. As mentioned previously, and discussed in greater detail below, such an arrangement may be used in places like shopping malls to provide location-specific information such as local maps, information on nearby shops and restaurants and so on, with a beacon downloading information keys to a mobile device. An information key is a small data object that provides a reference to a source of full information, and it is in the form of a number of predetermined fields, one of which will contain a short piece of descriptive text presented to a user. Another field will be a pointer or address of some form, for example a URL or telephone number. Other supplementary fields may control how the data is presented to a user and how the address may be exploited. A beacon will generally broadcast cyclically a number of these keys, each typically relating to a different service although, as will be recognised, waiting for the appropriate key can sometimes be a time-consuming business.

Issues relating to the beacon construction and configuration include the beacon range which will be dependent on output power (typical range being 1 mW to 100 mW), levels of local interference, and receiver sensitivity.

The user's CA terminal 10 comprises an aerial 16 coupled with transceiver stage 18 for the reception and transmission of messages. Outgoing messages result from user input to the telephone, either audio input via microphone 20 and A/D converter 22 or other data input via the keypad or other input means 24. These inputs are processed to message data format by signal and data processing stage 26 and converted to transmission format by encoder 28 before being supplied to the transceiver stage 18.

Messages received via the aerial 16 and transceiver 18 are passed via a decoding stage 30 to a filtering and signal processing stage 32. If the data carried by the message is for presentation on a display screen 34 of the telephone, the data will be passed to a display driver 36, optionally after buffering 38, with the driver formatting the display image. As will be recognised, the display 34 may be a relatively simple low-resolution device, and the conversion of received data to display data may be carried out as a subset of the processing stage 32 functionality, without the requirement for a dedicated display driver stage.

Where the message is carrying data from one of the beacons 14, the telephone has the ability to filter the information received according to pre-stored 40 user preferences and the user is only alerted (i.e. the information will only be retained in buffer 38 and/or presented on screen 34) if comparison of stored preference data and subject matter indicators in the message indicate that an item of data of particular interest has been received.

For conventional audio messages, the audio data is output by the filter and processing stage 32, via D/A converter 42 and amplifier 44 to an earphone or speaker 46. Receipt of such messages from the telephone network 48 is indicated by arrow 50: the telephone network 48 also provides the link from the telephone 10 to a wide-area network (WAN) server 52 and, via the WAN 54 (which may be the internet), to one or more remote service providers 56 providing a source of data for the telephone 10.

Communication between the CA terminal (telephone 10) and the CA base stations (beacons 12 and 14) takes two forms: ‘push’ and ‘pull’. In ‘push’ mode, inquiry information is broadcast by the beacon 12 to all portable terminals 10 in the form of a short ‘key’ indicated at 60. As will be described in detail below, the telephone 10 responds to the inquiry key by sending an identifier for itself to the first beacon 12, which then transfers the interaction to the second beacon 14 whilst the first continues to broadcast inquiry keys.

Other forms of key are received by the telephone 10 ‘unconsciously’, that is, without direct intervention by the user, and automatically filtered according to the user's pre-set preferences by a comparator function applied in processing stage 32. Suitably, the processing stage is operable to apply the comparator function in multiple simultaneous or overlapping copies such as to process in parallel the relatively large number of keys that may be received. Some will be discarded, some kept for further study, others might cause the user to be alerted immediately. By way of example, shops might choose to push details of special offers into passing terminals in the knowledge that users who have interest and have therefore set their filters 32 accordingly will be alerted by their terminal.

Sometimes the user will wish to obtain more information than is contained in the keys. Here, ‘pull’ mode allows a user to set up a connection with a server 56 (which need not necessarily be specially configured for CA use) and actively request information to pull down into the terminal 10. This mode is therefore typically interactive.

One proposal of the applicant is to label one beacon 12 as an ‘inquirer’ beacon, and it sends out Bluetooth inquiry messages constantly. The (or each) other beacons are labelled as ‘interactor’ beacons and allowed to communicate with terminals 10 on a one-to-one basis on request. Here, the inquiry procedure is performed by an inquirer beacon 12 and the paging procedure by an interactor beacon 14. By delegating the functions this way, it is possible to save a considerable amount of time that would otherwise be lost in attempts to join piconets.

FIG. 2 is a block schematic of a dual beacon system illustrating, by the numbers in parentheses, the sequence of message transmission. In this basic system, there is one inquirer beacon 12 and one interactor 14, although it will readily be understood that the system may be expanded to a networked infrastructure of plural beacons and interactors. The inquirer beacon 12 constantly transmits inquiry packets (1), which are used to discover the identities of any clients—portable devices—in range of the beacon. Once a client 15 comes into range, it will respond to the inquiry (2), giving the inquirer information about its identity.

The information about the client discovered is then transmitted over a secure channel (typically over fixed infrastructure) to the interactor beacon 14 (3)—a beacon solely concerned with transmitting information to the client. This then begins service interaction (4) by issuing a page message containing the client's identity to which the client 15 will respond.

Although the client is obliged to go through the inquiry and paging processes, the fact that the inquirer can issue inquiry packets continuously makes the process much quicker. The use of a separate beacon 14 for all interactions means that the inquirer does not have to pause to issue page messages, nor does it have to stop to allow interactive traffic. The client therefore never has to wait for the inquirer to enter inquiry mode. This in itself is a significant saving of time. As an added bonus, the interactor beacon does not have to wait for an Inquiry cycle to complete before issuing a page message and some seconds can be saved here as well.

FIG. 3 is a schematic of a multiple beacon network where the idea above can be extended to larger networks containing several interactors A, B, C, and, often, more than one inquirer 1.

Multiple interactors can be associated with one inquirer allowing location-specific content to be sent to the client. As with the dual beacon system, the inquirer passes the identities of clients to all interactors in the network. This means that, while a client remains in range of the network, it will only ever have to go through the inquiry process once.

Once the interactors know the identities of the clients, these can then begin the task of performing the service interaction. They can all page all clients continuously. When a client walks within range of one interactor, it will respond to the page by setting up a link with that interactor. The other interactors will typically cease paging for that client until the link is cleared. More advanced paging schemes will page only in nearby cells on the grounds that the user will have to walk through one or more of them before he can reach cells located further away. This way, large systems can page in economical fashion. Other paging strategies are also possible.

An alternative approach is to allow the terminal to request that it be placed in parked mode. In parked mode, the terminal is given a special identity by the interactor (as a Bluetooth master). It then sleeps for much of the time, waking periodically to resynchronise itself to the master and to listen to special beacon messages for possible instructions, including page messages. If the user decides to perform some interaction, the terminal wakes up and requests a link with the master. Interactive operation can then proceed as before.

In the wide area network set up, the terminal's special park mode identity is known to all interactor beacons in the system. This gives the ability for the terminal to enter park mode at one site and wake up at another without the need to go through the inquiry process.

As mentioned, more than one inquirer beacon may be part of the system. A shopping mall might place one at each entrance to the building, for example. Naturally, with such a distributed system, it will not matter at which inquirer beacon the client terminal completes the inquiry process.

By spreading the functions of Inquiry and interaction, considerable savings in time are achieved because the need to sign up to a piconet at each beacon is removed. As it stands, however, the client still needs to request information of the interactor beacons, even broadcast information. This requires the client to transmit and, in so doing, reveal its identity before establishing whether or not the information available is of any interest.

A mechanism for sending broadcast information over inquiry packets has also been proposed by the applicant/assignee. This proposal introduces an extra field to the Bluetooth Inquiry message for carrying keys or broadcast information during the inquiry procedure. This requires the guard space conventionally allowed at the end of the Bluetooth packet to be reduced, but this has found to be a practical solution to enable CA receivers to receive broadcast data quickly without being required to join the Bluetooth piconet.

With a multiple beacon network, more inquiry beacons—utilised to offer broadcast information at various locations—could supplement the distributed architecture developed above. A client that wants to know more about a particular piece of information issued by an inquirer can turn to any interactor and set up an interactive link. As a possible bonus, the terminal does not have to submit to the inquiry process as it enters the shopping mall (or other area where the beacons are located) but may hold off until such time as it discovers an interesting broadcast message.

Several other functions can take advantage of a distributed fixed part network. Of these, one of the most important is call hand over or handoff. This function allows a terminal, which has a link active, to transfer the link from one fixed cell to another, ideally (for voice mode) in a seamless fashion. By distributing the management of terminal identities and link functions at the fixed side, hand over in large area, multiple cell fixed networks becomes possible in Bluetooth and similar protocols.

The architecture described above is described in greater detail in commonly-assigned International patent application EP 01/06949, entitled “An Efficient Method for Delivering Services over Beacons” (priority date Aug. 15, 2000).

This invention is specifically concerned with problems related to the structure of pushed messages and also the architecture of complex networks of beacons, and relates to the processing of pushed messages in a handset with or without the above mentioned faster connection time modification.

Thus, the invention may benefit from the use of data embedded within the Bluetooth inquiry packets, but it may be implemented using the more conventional Bluetooth system or indeed using other communications protocols.

The invention will now be described with reference to the arrangement of beacons in FIG. 4. Each beacon is represented by a dot 70, with the enclosing circle 72 representing the range or “Sub Aura” (SA) within which radio communication to a handset is possible. The beacons 70 are arranged in two groups 74, 76 or “Master Auras”, where each Master Aura represents a co-ordinated system providing a particular range of CA services and information.

It is important that the initial alert to the user is as appropriate as possible to the contents of the message. Any unnecessary ambiguity in the alert may distract the user, and cause them to waste time checking information that should have been alerted as of low priority. This would be very damaging to the user's perception of a service which must have low demands on the user's time if it is to be accepted. To this end, a different sound can be related to each individual alert. This sound could be obtained from the nearest beacon following reception of a pushed message. However, the time for this procedure could lead to an unacceptable delay, and an excessive load on an individual beacon. This problem is magnified if the alert relating to a particular message has either a number of variants, perhaps representing different priorities, or a number of components, perhaps an image as well as a sound.

The proposed solution to the problem is to provide a short alert message from the beacon to the mobile receiver, which has preloaded interpretation data enabling the specific alert signal to be interpreted to give rise to the desired audio, visual or vibration message at the wireless receiver. This message is effectively selected by the beacon and is an alert message of the transmitter beacon.

A range of user devices 10 (phone, PDA, etc) can receive the alert signals and display the corresponding alert messages. There are different types of alerts, an information alert, an advertisement, or an alert that a friend is nearby are three examples.

The CA scenarios are directed at people on the move who may only be in range of a beacon 12 for a short time. This is dependent on the transport technology, bandwidth and speed of user. In CA Bluetooth is being used to deliver the alert to the user device 10. Here a short packet of information may be sent to the user as he walks past a beacon 12.

When the user receives the alert signal, typically the alert message will comprise an alert sound being played and an image being displayed on the screen of the device. These sound and image files (named “interpretation data” in this text) consume memory and the invention avoids using time to deliver these to the device 10. Instead, the alert signals are essentially pointers to these files, that are stored locally on the device 10. These files may have been put on the wireless receiver when the alert application was installed or alternatively they may have been downloaded by another beacon 12 during a previous interaction. For example, as the user enters a shopping mall a beacon 12 may download the interpretation data to the user device that might be used by beacons 12 belonging to stores within the mall—such as a Virgin Records logo. Alternatively the interpretation data may be downloaded to the device 10 by the user at his/her home. This may be accomplished by dialing in to a provider, or by connecting somehow (wireless or wired) to his own PC.

The user may also configure the device 10 with his own preferred interpretation data so that when an alert is received a user defined sound is played and a user defined image is displayed. So if the user has preferred alert messages, these may be activated upon receipt of an alert.

The alert signal sent to the user device 10 may contain information that is perishable. The alert signal may contain a validity duration value. If this time expires then the alert message is removed from the display of the device. This may be used to send special offers or timely information such as next train home.

As mentioned above, it is possible to provide the interpretation data from a designated beacon. To achieve this, the invention provides a particular organisation of beacons into groups of a number of beacons, each of which is coordinated as a single system for delivery of the messages of a particular operator. The operator of the beacon group will select one or more of the beacons in a Master Aura to operate as “Initialiser” beacons. The Initialisers have the task of preparing a handset for interaction with any of the other beacons in the Aura, in particular by providing the interpretation information to the receivers, so that the receivers can correctly interpret short-form messages from the beacons.

The Initialiser beacon may transmit this interpretation data as data appended to the Bluetooth inquiry message. The initialiser beacon may be a higher power device than the other beacons of the network, and therefore have greater range. This enables the user to be within range of the beacon for sufficient time to download sufficient quantities of information, such as audio files and graphics icons.

The provision of the interpretation data may take place using any of the following procedures:

Audio Alert Pre-Load

The interpreation data can include sound files to be pre-loaded from the Initialiser beacon which the handset should use for alerting the user to messages within the current Master Aura 74, 76. This reduces the transmission overhead on individual beacon interactions, and means that they will be available for use immediately. A set of sounds would be preloaded, maybe relating to different priorities of the same message (one sound for “urgent” another for “neutral”). Another ordering would have a different sound available for a particular class of alert (one sound relating to messages in Sub-Aura A, another for Sub-Aura B).

It could be appropriate for the Initialiser beacons to be located where first contact with handsets is expected, probably by the entrance or stairs leading to a new Master Aura. Each handset entering the Master Aura will now be “captured” and fully prepared for generating alerts whenever appropriate from that point onwards. Alternatively, “Initialiser” may just refer to an operating mode of a beacon, which any beacon in a Master Aura may switch to as required. Some kind of expiration lifetime will be necessary, so that resources allocated to the sound files can be freed when they are unlikely to be of further use (for example, a few minutes after the last contact with a beacon in a Master-Aura).

The audio alert pre-load idea is of greatest use for more advanced implementations of beacon networks which use broadcasting of pushed messages.

Message Pre-Filter

The hierarchy of beacons provided by the invention, with Master-Auras controlling Sub-Auras, gives the potential for message pre-filtering. With this concept, an Initialiser learns of the identity of a handset during its Initialisation communications. This identity can be passed on to all Sub-Aura beacons, along with some basic profile information downloaded from the handset receiver. Individual beacons will then be able to filter potential messages so that only those which are relevant to the profile of the user or users within the Master Aura are transmitted. Of course, this does not preclude further filtering on the handset side after reception of a pushed message.

Pre-Load for Data Retrieval from Cellular Link

Another benefit of Initialisers can be found when a user decides to ask for more content relating to a message from a particular alert. At this point, the user gives the handset an indication that more information is required, possibly by a simple button press. This leads to the creation of an external cellular data connection, which is used to access relevant databases or web pages that can service the information request. The process of creating a data connection can take many seconds, perhaps 30 seconds for a normal WAP connection over GSM. This period of time is far too long for a user to endure without activity. However, the Initialiser scheme could be used to preload some content to the handset which can be displayed during the connection procedure. With appropriate planning, this content may even include user interaction, such as a WML menu for specifying more accurately the details of the information request. After 30 seconds, the connection will have been made and these additional parameters from the user can be passed to the data provider. By having a task to perform, the user may not even have been aware of the delay.

The operation of the embodiment illustrated in FIG. 4 will now be described in further detail. Master Aura 74 in this case relates to a particular department store, and Master Aura 76 relates to some unrelated location in which the handset is initially located. The handset moves along the path from A (in Master Aura 76) to B (in Master Aura 74 within range of Sub Aura beacon 1) to C (in Master Aura 74 within range of Sub Aura beacon 3). At point A, it has no knowledge of the Shopping Centre Aura 74. As it reaches B, it comes into contact with the Initialiser beacon 70a of the Shopping Centre. It passes its identity to that beacon, and some simple profile information. In return, it receives a set of three sound files, one for each of the other Sub Aura beacons. It also obtains a WML menu appropriate to a current promotion happening in the store.

On moving to C, the Sub Aura beacon 3 detects the presence of the handset. This beacon, located perhaps in the toys department, uses the profile information it has received about the user (transferred from the initialiser) to design an appropriate push message. This is transmitted to the handset, and in this example offers the user a special offer on some computer games software.

This alert information can be sent in a number of ways. For example, a beacon may detect that a device is nearby, and the beacon then sends the alert directly to the user. Alternatively, the beacon may send information in the inquiry phase to all users within range. The alert sent will comprise one or more of a short chunk of text, a URL, a pointer to an audio file and a pointer to an image file.

The handset decides that this class of message is appropriate for alerting to the user, and plays the relevant sound file and displays the relevant image file that has been stored since contact with the initialiser beacon. The user decides that more information is desirable, and confirms this with a button push on the handset, or selects a URL presented. At this point, a WAP connection is requested (or other available wide area network). During the connection period, the user fills in some details on a WML form which is presented from the handsets memory. Again, that form was stored since contact with the initialiser beacon. When the WAP connection is available, the additional parameters are passed in the information request to an appropriate URL. For the example, the added details may relate to the particular type of game the user wishes to buy, and how much they are willing to spend on this occasion.

This invention can be used in systems providing location aware services, such as could be found in places like shopping malls, airports, stations, conference centres, museums and sports venues.

As described above, one possible implementation of the CA arrangement divides the phases of inquiry and interaction across different radios to speed up the inquiry process. In this case, the inquirer can generate a rolling list of valid Bluetooth handset device addresses, the list being passed on to the interactors for immediate data exchange. This list can be large: tens or even hundreds of discovered devices passing a fixed inquirer eg at an entrance gate to an installed environment of beacons.

An interactor radio is thus given the job of polling those Bluetooth addresses on its list and guaranteeing the transmission of some data to those handsets. Unfortunately, this involves paging the devices in turn before data transmission. The simple paging mechanism itself can take about two seconds per device, and although there are some Bluetooth Special Interest Group proposals to speed paging up, it may still be of the order of a second per device. Therefore, in very crowded places of interaction, there is still a load problem. If paging takes one second, then only about eight devices can guarantee to be serviced (less with any significant data exchange per device) in the time it takes a walking user to pass out of the 10 meter range of the interactor radio (in time terms 5-8 seconds).

One possibility is therefore to cluster a number of interactor radios together in the same place and partition the allocation of the complete list of discovered Bluetooth handset addresses across the interactor radios. For example, the first radio handles first 5 device addresses, a second radio handles the next set, etc. So the cluster of radios might consist of 1 inquirer and 10 interactors together, to handle simultaneous interaction with 80 people in a 10 meter zone such as a train station concourse. According to the expected peak crowd numbers expected, then the number of radios required in a place can be estimated.

A further extension is possible when there is a geographical hierarchy of beacons, with some interactors serving non-overlapping zones, for example interactor number 5 does not overlap with the zone of interactor number 11. Now, some dynamic screening of the device address lists of the interactors can be performed. Any Bluetooth interaction with a device returns to the interactor radio (with v1.1 Bluetooth, not of course with connectionless-broadcasting) the handset device's ID, Bluetooth address with which it had that exchange. Knowing the layout of beacon coverage, it is therefore possible to say that if that handset is in range of interactor 5, then interactor 11 does not have to try to poll that Bluetooth address, and so on. The device address lists for each interactor radio can then be dynamically filtered to discard devices that are already currently being interacted with elsewhere, taking into account the possibility of a handset moving at a given maximum speed from one coverage zone to the adjacent one.

From reading the present disclosure, other modifications will be apparent to persons skilled in the art. Such modifications may involve other features which are already known in the design, manufacture and use of fixed and portable communications systems, and systems and components for incorporation therein and which may be used instead of or in addition to features already described herein.

1. A communications system comprising:
a transmitter beacon for transmitting a plurality of alert signals to wireless receivers within range of the beacon, each alert signal being provided for prompting an alert message of the transmitter beacon; and
a wireless receiver which stores interpretation data, selected interpretation data being used when an associated alert signal is received, thereby to generate the associated alert message at the mobile wireless device.

2. A communications system as claimed in claim 1, wherein the interpretation data comprises sound or image files.

3. A communications system as claimed in claim 1, comprising:
a first group of beacon devices for wirelessly broadcasting data, the wireless receiver being for receiving data from the beacon devices of the first group,
wherein at least one of the beacon devices of the first group is arranged to provide the interpretation data to the wireless receiver to enable the wireless receiver to interpret signals from the beacon devices of the first group.

4. A communications system as claimed in claim 3, further comprising a second group of beacon devices for wirelessly broadcasting data, wherein the at least one wireless receiver is for receiving data from the beacon devices of the first and second groups and wherein at least one of the beacon devices of the second group is arranged to provide interpretation data to the wireless receiver to enable the wireless receiver to interpret signals from the beacon devices of the second group.

5. A communications system as claimed in claim 3, wherein the at least one of the beacon devices of the first group of beacons are arranged to receive data relating to the identity of the wireless receiver during the provision of the interpretation data.

6. A communications system as claimed in claim 5, wherein the at least one of the beacon devices of the first group of beacons comprise means for passing the data relating to the identity of the wireless receiver to the other beacon devices of the respective group of beacons.

7. A communications system as claimed in claim 5, wherein the data relating to the identity of the wireless receiver comprises the identity and/or profile information concerning the wireless receiver.

8. A communications system as claimed in claim 5, wherein the other beacon devices of the first group of beacons each comprise filtering means to filter potential messages in dependence on the data relating to the identity of the wireless receiver.

9. A communications system as claimed in claim 1, wherein the interpretation data comprises content which can be displayed during a connection procedure.

10. A communications system as claimed in claim 1, wherein each beacon device is for broadcasting data using the Bluetooth protocol.

11. A method of providing information to a mobile receiver from a beacon device, the method comprising:
providing interpretation data to the wireless receiver to enable the wireless receiver to interpret signals from the beacon device; and
providing a signal from the beacon device when the wireless receiver is within range of the beacon device, the wireless receiver interpreting the signal using the interpretation data.

12. A method as claimed in claim 11, wherein the beacon device is one of a group of beacon devices, and wherein the interpretation data is provided to the wireless receiver from a second beacon device when the wireless receiver is within range of the second beacon device.

13. A method as claimed in claim 11, wherein the interpretation data is provided to the wireless receiver during a preload operation remote from the beacon device.

14. A method as claimed in claim 13, wherein the preload operation is carried out over the internet.

15. A method as claimed in claim 11, wherein the interpretation data comprises sound files.

16. A method as claimed in claim 11, wherein the signal is provided using the Bluetooth protocol.

17. A method as claimed in claim 16, wherein the signal is provided as a data field within the Inquiry signal of the Bluetooth protocol.

18. A method as claimed in claim 11, wherein the wireless receiver is movable between a plurality of groups of beacon devices, and wherein the method comprises:
providing interpretation data from a first beacon device within each group to the wireless receiver when the wireless receiver is within range of the first beacon device; and
providing a signal from a second beacon device within the group when the wireless receiver is within range of the second beacon device, the wireless receiver interpreting the signal using the interpretation data.
